(19) United States
(12) Patent Application Publication
(10) Pub. No.: US 2011/0220767 A1
(43) Pub. Date: Sep. 15, 2011

(54) PEDESTAL ATTACHABLE TO SERVING DISH WITH SUCTION CUP

(76) Inventors: Anna M. Stewart, Naples, NY (US); Stephen Kraigh Stewart, Naples, NY (US)

(21) Appl. No.: 13/039,871

(22) Filed: Mar. 3, 2011

Related U.S. Application Data
(60) Provisional application No. 61/313,752, filed on Mar. 14, 2010.

(51) Int. Cl. F16B 47/00; F16M 11/04; B23P 11/00

(52) U.S. Cl. 248/121; 248/205.8; 29/428

(57) ABSTRACT

An attachable pedestal that can be attached to the underside of a plate, serving platter, bowl, serving dish, or the like. The attachable pedestal includes a pedestal with a base that can rest on a surface, and a suction cup that can be attached to an object thereby adjoining it with the pedestal. To facilitate the attachment and retention of the pedestal to the object, a support structure is provided under the suction cup. The support structure is biased towards the suction cup such that when a downward positive force is applied to the suction cup by pressing down on the object, the support structure applies an upward positive pressure. In cooperation, the downward pressure against the suction cup and the upward pressure against the suction cup operate to evacuate air from the cavity of the suction cup. The support structure also provides under support to stabilize the attached object.

### CROSS-REFERENCE TO RELATED APPLICATIONS

This application claim the benefit of the priority date of United States Provisional application for patent that was filed on Mar. 14, 2010 and assigned Ser. No. 61/313,752, which application is incorporated herein by reference.

### TECHNICAL FIELD

The present disclosure is related to the field of attachable pedestals or stands and, more particularly, to a pedestal, stand or holding device that can be securely attached to a device for use or display of that device.

### BACKGROUND

In the south, and it may even occur north of the Mason Dixon line, many a grandmother has a wall reserved in their dining room on which they hang an array of plates for display. The reasoning behind this practice is not fully clear, other than that some people are obviously so fond on their plates, that they want to decorate their homes with them.

Then, there is that “special” platter that is always brought out for a party or holiday dinner on which the wonderfully crafted finger-foods are decoratively arranged. The platter special platter the festive display of munchies is then plopped on the table or counter, and then somewhat hidden, or at least the overall decorative effect is somewhat diminished as the casserole dishes, olive tray, and glasses of ice are sprawled around the special platter.

Now, occasionally an imaginative host, one that actually owns a cake stand, will realize that the cake stand could be used in lieu of the special platter. The result is that the decorative arrangement of morsels are then raised up above the crowd of casserole dishes, olive trays and glasses and remain easily accessible for viewing or for grabbing. But alas, that special platter then gets supplanted by the cake stand. However, there are the others that simply would refuse to use a cake stand to ensure that their special platter is utilized.

And then how many people actually have a cake stand? They are awkward to store and basically, to be available for multi-occasional uses, they are generally blandly generic. How nice it would be to have sufficient cabinet space for a Christmas cake stand, a Thanksgiving cake stand, a St. Patrick's Day cake stand, etc.

What is needed in the art a solution for this cake stand and platter dilemma A solution that, for a lack of better words, allows the possessor of that special platter to have their cake and eat it too. Thus, there is a need in the art for a method or device that can convert a platter or other serving dish into a cake stand. Stated differently, there is a need in the art for a method or device than can be attached to a serving dish so that the serving dish is then safely equipped with a pedestal.

### BRIEF SUMMARY

The present disclosure presents various embodiments, as well as features and aspects thereof, of a pedestal that can be attached to a variety of surfaces to provide support. More specifically, one embodiment includes a pedestal for attachment to a surface of an object. The attachable pedestal includes a base with a top portion and a bottom portion. Extending from the top portion of the base is a neck that extends from the top surface of the base and having a first end that is proximate to the base and a second end that is distal from the base. Further, the attachable pedestal may include a mating support having bottom side corresponding to and extending from the end of the neck that is distal from the base and a top side that includes or receives a mating element.

The mating element includes structures for attachment to the surface of the device, as well as additional structures to provide stable support of the attached device. Thus, the mating element may include a mating attachment that is configured to attach to the surface the object and a support structure that is configured to provide support for the object. Advantageously, such an embodiment can be attached to the underside of a plate, bowl, serving platter, serving dish, etc., and securely mount the same to the pedestal to create a decorative serving dish or functionally to enable the object to be more readily viewed or accessed.

Embodiments may include an apparatus for attachment to a surface of an object. The apparatus includes a base, a neck and a mating support. The base has a first surface corresponding with a plane, and a second surface. The neck that extends from the second surface of the base and has a first end that is proximate to the base and a second end that is distal from the base. The mating support has a first side and a second side. The first side of the mating support corresponding to and extending from the end of the neck that is distal from the base, and the second side including the mating element.

The mating element includes a flexible mating attachment and a rigid support structure.

The flexible mating attachment is attached to the apparatus and is configured to attach to a surface an object. In some embodiments, the mating element may a suction cup. In such embodiments, the suction cup may include a concave side for mating with the surface of the object and a plurality of flanges corresponding to the periphery of the suction cup and extending in a radial manner from the periphery of the suction cup, at least one or more of the flanges including a tab that extends towards the concave side of the suction cup, wherein when the object is attached to the suction cup, the tabs provide additional support to the object. The suction cup is rigidly attached to the apparatus, such as by screwing into a threaded hole or otherwise.

The rigid support structure is separate and distinct from the flexible mating attachment and that is configured to provide support for the flexible mating attachment and the object. The support structure lies between or is sandwiched between the second side of the matting support and the suction cup. The support structure can be biased to apply a force against the flexible mating attachment, or suction cup in some embodiments, such that when pressure is applied against one side of the suction cup by pressing the surface of the object against the suction cup, the support structure operates to apply an opposing force on an opposing side of the suction cup. Further, the support structure can be configured such that the force applied to the opposing side of the suction cups operates to vacate air from the suction cup.

As for the biasing element, the neck may include a biasing member that engages with a bottom surface of the support structure and that operates to bias the support structure towards the suction cup. In some embodiments, the biasing member may be a spring. Further, the neck may define an interior cavity and further comprise a threaded aperture that is accessible through the interior cavity of the neck accessible through an opening in the end neck located that is distal from the base, and the suction cup may include a threaded rod that can be mated with the threaded aperture to provide the rigid attachment of the suction cup to the apparatus. Further, in such embodiment the support may define an aperture through which the threaded rod is be extended when assembled. In some embodiments, the threaded aperture is integral to an insert that can be attached to the combination of the base and neck.

Other embodiments may be an apparatus for attachment to the surface of an object where the apparatus includes a suction cup and a support structure. In such embodiments, the suction cup includes a concave surface for attachment to the surface of an object and an opposing surface. The support structure corresponds to the opposing surface of the suction cup and is biased towards the suction cup such that when pressure is applied against the concave surface of the suction cup by the surface of the object, the support structure applies an opposing pressure against the opposing surface of the suction cup so as to facilitate the evacuation of air from a cavity defined by the concave surface of the suction cup. Such embodiments may also include a base with a first surface and a second surface. The first surface of the base being substantially flat and defining an outer edge, the second surface of the base being substantially tapered inward from the outer edge such that the first surface of the base is substantially wider than an upper portion of the second surface of the base. The embodiments may also include a neck that extends from the upper portion of the second surface of the base substantially perpendicular to the first surface, the neck having a first end that is proximate to the base and a second end that is distal from the base, the neck being substantially narrower than the first surface of the base. Finally, such embodiments may also include a mating support having a first side and a second side, the first side of the mating support corresponding to and extending from the end of the neck that is distal from the base, the second side receiving the suction cup and the support structure.

The opposing side of the suction cup in various embodiments may include a threaded stem extending from the suction cup in the opposite direction of the concave surface. To receive such an element, an embodiment may include an insert that is configured to slide into the interior of the neck and including an interior structure defining a threaded aperture centered coaxially within the insert. Further, the insert may include a spring that is configured to fit inside the insert with a first end of the spring resting on the interior structure of the insert. Such embodiment may include a means for securing the insert within the interior of the neck and an opening in the insert for receiving the narrow end of the support structure. Thus, the insert can be inserted into the neck and secured into position, the spring can be inserted into the insert, the support structure can be inserted into the opening of the insert with the inserted end of the support structure resting against a second end of the spring, and the suction cup can be attached to the insert by inserting the threaded stem through a hole defined by the support structure, through the center of the spring and threading the threaded stem into the threaded aperture of the insert.

Other embodiments, configurations, features and aspects of the various embodiments are described in more detail in the detailed description with reference to the attached drawings.

### BRIEF DESCRIPTION OF THE SEVERAL VIEWS OF THE DRAWING

FIG. 1 is an exploded perspective diagram illustrating the various components of an embodiment of the attachable pedestal particular well suited for attachment to a serving dish, platter or bowl.

FIG. 2 is a cross-sectional diagram of the assembled attachable pedestal device illustrated in FIG. 1 with the cross-section corresponding to the line A-A in FIG. 1.

FIG. 3 is a perspective view of an attachable pedestal.

FIG. 4 is a perspective view of another embodiment of an attachable pedestal.

FIG. 5 is a front view of the embodiment of the attachable pedestal illustrated in FIG. 4.

FIG. 6 is a side view of the embodiment of the attachable pedestal illustrated in FIG. 4.

FIG. 7 is an enlarged front view of top section of the embodiment of the attachable pedestal illustrated in FIG. 4.

FIG. 8 is an enlarged side view of the top section of the embodiment of the attachable pedestal illustrated in FIG. 4.

FIG. 9 is an enlarged top view of the embodiment of the attachable pedestal illustrated in FIG. 4.

FIG. 10 is an enlarged side view of the suction cup utilized in the embodiment of the attachable pedestal illustrated in FIG. 4

FIG. 11 is a 3D model perspective view of another embodiment of the attachable pedestal.

FIG. 12 is a 3D model perspective view of the top and/or bottom section of the embodiment of the attachable pedestal illustrated in FIG. 11.

FIGS. 13A-B, 14A-B and 15A-B illustrate an exploded view of the top and/or bottom section of the embodiment of the attachable pedestal illustrated in FIG. 11.

### DETAILED DESCRIPTION OF EMBODIMENTS

The present disclosure, as well as the described features and aspects of various embodiments, is directed towards providing a pedestal or stand that can be securely attached to a surface of a serving dish, platter, bowl, tray or other device so that the device can be displayed or utilized.

Although throughout the detailed description, the various embodiments are largely described as an attachable pedestal, which would be utilized in a substantially vertical orientation and rest on a horizontal surface, it should be understood that the focus of such description is only provided to ensure clarity in the configuration and operation of the various embodiments and, the description should not be used to limit the usefulness of the various embodiments in other manners or for other uses. For instance, embodiments of the attachable stand may be suitable for horizontal uses, diagonal uses, holding devices vertically, horizontally or at an angle, displaying objects, hanging objects, securing objects, etc.

In general, one example of an embodiment includes a pedestal that is particularly well suited for operating as a pedestal to convert a serving dish or platter into cake stand or simply a pedestal-equipped serving dish. Such an embodiment includes a base, a neck and a mating support and, advantageously can be attached to the surface of an object, such as a platter, serving dish or bowl as non-limiting examples.

The base includes a lower surface that is suitable for sitting or resting on another surface, such as a table or counter. The lower surface may be flat, substantially flat, or include feet and our contours to facilitate gripping or otherwise providing a stable interface with the resting surface. Thus, in essence the base or at least a portion of the base may correspond to a plane such that the base can be set upon or rest against a surface in a parallel plane that is juxtaposed with the lower surface of the base, such as a table top, counter top, wall, or any similar surface. The base, in general, is structured to be sufficiently wide, or have a sufficient footprint to provide necessary support for the intended use of the device. For instance, in a cake stand embodiment, the base should be sufficiently wide to allow a person to apply pressure on the side of an attached platter while cutting or serving the cake without allowing the assembly to tip over or topple. In some embodiments, interchangeable or modifiable bases may be used to allow the stand or pedestal to be utilized for a variety of purposes. For instance, in one embodiment, bases of various sizes and/or configurations can be interchanged depending on the intended use. In other embodiments, the base may include attachments that can broaden the width of the base. Yet in other embodiments, bases of different material can be used to provide a heavier weighted base for added stability. Other embodiments may allow weighted elements to be attached to the base to provide added stability. The various configurations of the base may include other features such as one or more suction cups for being secured to a surface, adhesives, magnets, holes for mounting the base to a surface, a threaded end for mating with a threaded support mechanism on the surface (i.e., a threaded protrusion extending from the base may be screwed into a threaded hole in a counter or, a threaded protrusion on a surface may be screwed into a threaded hole in the base, etc. Also, embodiments that do not include a base are also anticipated. For instance, the neck may mount directly to a surface. As another example, a surface may define a hole or cavity and the neck may be slid into the same and secured in place. In yet another embodiment, a rod or pole may extend from the bottom of the neck and be slid into a hole or cavity in other surface.

The neck extends from an upper portion of the base and can be of a variety of different lengths depending on the desired height. In some embodiments, the neck may be expandable using various techniques. Non-limiting examples include telescoping, having multiple sections that can be added or removed as desired, threaded sections that can be rotated to expand or shorten the neck, as well as other techniques.

The mating support extends from the upper portion of the neck and houses the element that attaches to the surface of the object.

The base, neck and mating support are collectively referred to as the pedestal. It should be appreciated that in some embodiments, the pedestal may be two or more distinct pieces that are joined together using any of a variety of techniques. For example, the pedestal may include a base, neck and mating support that are screwed, glued, welded or otherwise joined together. In other embodiments, the pedestal may be a single element that can be molded, formed, cast, machined, etc. The pedestal can be constructed from a wide array of materials including plastics, silicon composites, metals, woods, ceramics or any of a variety of composite materials or other suitable material. As such, the pedestal can be a rigid material or a flexible material but, in general, the pedestal should be sufficiently rigid to provide support to the attached objects.

The profile of the pedestal may exist in a variety of shapes. In the illustrated embodiments, an hour glass like shape is presented. However, it will be appreciated that many additional shapes may also be employed depending on the desired function and aesthetics desired for the pedestal. A few non-limiting examples can include a based and/or mating support that are squared, rectangular, triangular, round or circular, oval as well as other shapes. Similarly, the neck can be in a variety of shapes and the shape can vary over the length of the neck. For instance portions or all of the cross section of the neck may be round, square, rectangular, triangular, oval, twisted, braided, etc. In addition, the neck may extend in a single direction in some embodiments, while in other embodiments, the neck may have curves or turns over its length. As a non-limiting example, in one embodiment the base may be intended to rest on a horizontal surface and the neck may be curved such that the mating support attaches to a vertical surface. Such an embodiment could be used to mount to a picture, a computer monitor, a cookbook, etc.

The various embodiments that are described in detail and that are illustrated only include a single neck. However, it should be appreciated that in some embodiments, multiple necks of the same or different lengths, as well as different shapes, configurations and/or orientations. As a non-limiting example, an embodiment may include three necks as well as three mating supports that can support three different platters or serving dishes being mounted to the pedestal. Such an embodiment may be particularly suitable for supporting bowls to serve a variety of dips, condiments, vegetables, etc. In other embodiments, the neck, or at least a portion of the neck may be adjustable. For instance, if at least a portion of the neck is constructed or a malleable material or using a structure similar to a microphone extension holder, then the neck can be adjust to different orientations. Similarly, the base may be configured as a multi-element structure. For instance, the base may include three or more legs that extend from the bottom of the neck, or one leg with a wide footprint and another leg with a narrow footprint, or two lets with wide footprints, etc.

The attachable stand or pedestal presented in this disclosure may be used for a variety of purposes. A few of these purposes are provided as examples to facilitate the understanding of the various embodiments but, should not be construed as limitations of the overall invention presented in this disclosure. As previously described and as described below, the attachable pedestal can be mounted to a serving dish or platter. Embodiments may also be used for mounting items, such as plates, pictures, artwork, mirrors, books, etc. to a wall. Embodiments may also be used for holding or securing items that are being worked or, such as an item being painted, cut, etc. Other uses and design alternatives not specifically described are also anticipated.

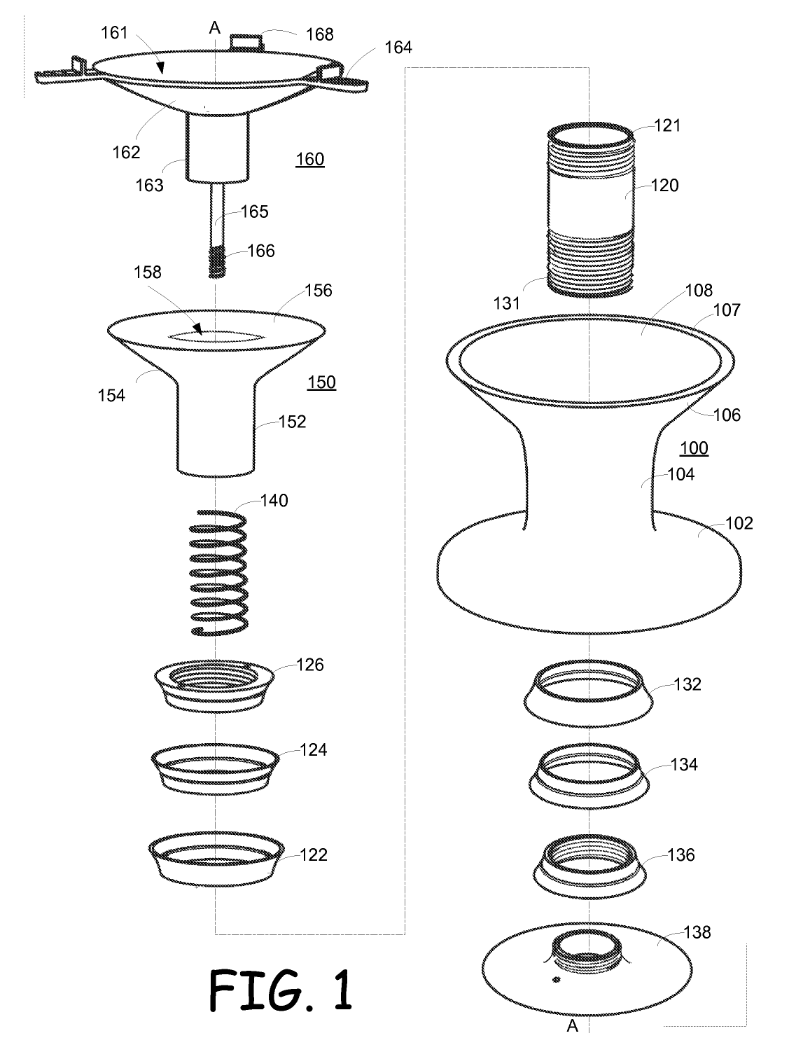

Now, turning to the figures, the various aspects and features of some embodiments of the attachable pedestal will be described in more detail. FIG. 1 is an exploded perspective diagram illustrating the various components of an embodiment of the attachable pedestal particular well suited for attachment to a serving dish, platter or bowl.

The illustrated embodiment includes a single piece pedestal 100 that includes a base portion 102, a neck portion 104 and a mating support portion 106. The pedestal 100 includes an exterior surface and an interior surface with the interior surface defining a cavity or hollowed out area 108.

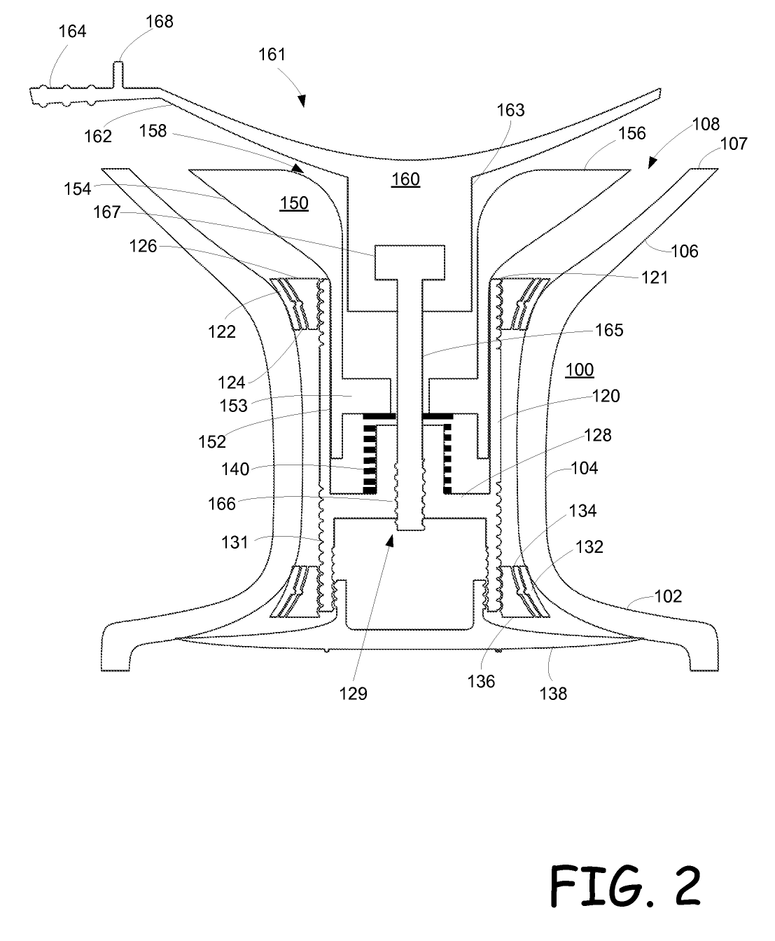

The illustrated attachable pedestal of FIG. 1 includes an insert assembly that is illustrated as including the following components: sleeve 120, upper-outer gasket 122, upper-inner gasket 124, upper threaded ring 126, lower-outer gasket 132, lower-inner gasket 134, lower threaded ring 136 and threaded bottom 138. In an exemplary embodiment, the sleeve 120 includes an internal structure 128 (illustrated in FIG. 2) that defines a threaded aperture 129. The sleeve 120 includes an upper end 121 that is threaded on the exterior of the sleeve 120 and a lower end 131 that is threaded both on the exterior and interior. The illustrated assembly is assembled, as one example, by inserting the upper end 121 of the sleeve 120 through the upper-outer gasket 122, then the upper-inner gasket 124 and then threaded into the upper threaded ring 126. Then the sleeve 120 can be slid into the upper opening of the pedestal 104 through the cavity 108 and inserting the lower end 131 of the sleeve 120 through the lower-outer gasket 132, the lower-inner gasket 134 and then threaded into the lower threaded ring 136. Finally, the threaded bottom 138 can be screwed onto the lower end 131 of the sleeve 120 by inserting the threaded portion of the threaded bottom 138 into the lower end 131 of the sleeve 120 and screwing it into place.

It should be appreciated that the structure presented in conjunction with FIG. 1 is a non-limiting example of one structure of the attachable pedestal. The presented structure is suitable for an embodiment in which the pedestal 100 is fabricated from a material such as ceramic, wood, tooled metallic, composite or other materials that can be tooled, etc. However, in embodiments that are cast or molded, some of all of the functionality provided by the insert assembly can be formed within the pedestal 100 itself in the molding or casting process; however, even in a casted or molded embodiment, the described insert assembly or a variation thereof can likewise be employed. It should also be appreciated that the disclosed insert assembly is only one non-limiting example of such a structure. For instance, other embodiments may combine two or more of the described parts or, utilize additional parts. In addition, those skilled in the art will appreciate that many additional configurations could be used to hold or secure the sleeve 120 within the interior of the neck 104 of the pedestal 100. Such additional configurations may include, as non-limiting examples, glue, adhesives, screws, clamps, friction, rubber or other flexible gaskets, pins, welding, mating protrusions and indentions, threading of the interior of the neck 104 and the entire length of the sleeve 120, etc.

The illustrated attachable pedestal also includes a spring or actuator 140, a mating support that includes a support structure 150 and a mating attachment 160. In the illustrated embodiment, the spring 140 is a coil spring that can be inserted into the sleeve 120 and rest on the internal structure 128 within the sleeve 120. The support structure 150 includes a lower cylindrical shaped portion 152 and an upper conical shaped portion 154. The upper conical shaped portion 154 defines a top surface 156 which in the illustrated embodiment is shown as being substantially flat. One of the functions of the top surface 156 of the support structure 150 is to provide a pressure or positive force against the mating attachment 160. In the various embodiments, this function can provide at least two benefits. First of all, the support structure 150 can assist in the actuation or adhesion of the mating attachment 160 to a surface by assisting in vacating the air. Secondly, the support structure 150 can provide additional support to the mating attachment 160 and the device or surface to which it is attached. The support structure 150 also defines a aperture or bore 158 that includes an opening in the upper surface 156 and extends through the lower cylindrical shaped portion 152. It should be appreciated that the disclosed structure deviates from the normal operation of a suction cup in which the suction cup is pressed against a non-moveable surface by applying pressure to the center of the backside of the suction cup. In the disclosed structure, the suction cup is stationary and a positive force is applied against the concave side of the suction cup by the weight of the device being attached or by pressing the device against the suction cup. Further, a positive force is applied against a portion of the convex side of the suction cup that is offset from the center of the suction cup.

The mating attachment 160, in the illustrated embodiment is a conical shaped suction cup defining an interior cavity 161 that is generally concave and an outer surface 162 that is generally convex. A cylindrical shaped protrusion 163 extends from the apex or bottom of the conical shaped suction cup and rod 165 depends from the lower portion of the cylindrical shaped protrusion 163. The rod 165 includes a threaded portion 166 that covers at least the end port of the rod 165 but, could also extend the full length of the rod 165. As best seen in FIG. 2, the rod 165 includes an enlarged portion or terminating portion 167 that is embedded within the cylindrical shaped protrusion 163 which serves to retain the rod 165 within the protrusion 163 and, can be irregularly shaped to prevent or limit the ability of the rod 165 to turn within the protrusion 163.

The mating attachment is also shown as including one or more fingers or protrusions 164 extending from the periphery of the conical shaped suction cup 160 in an outward radial fashion. Each such finger is shown as including an optional tab 168 that, as will be described in more detail following, can help provide support between the attachable pedestal and a device to which the pedestal is attached.

The assembly of the attachable pedestal illustrated in FIG. 1 is then completed by inserting the spring or actuator 140 into the sleeve 120, inserting the cylindrical portion 152 of the support structure 150 into the interior of the sleeve 120, inserting the rod 165 through the bore 158 and into the threaded aperture 129 and then screwing the rod 165 into the threaded aperture 129 to secure the elements together.

It should be noted that in the configuration illustrated in FIG. 1, the support structure 150 is floating in that the spring or actuator 140 rests against the bottom of the support structure 150 and biases the support structure towards the suction cup. The support structure 150 can thus move moved up and down by application of appropriate pressure to compress or relax the spring or actuator 140 against the support structure 150.

In operation, the attachable pedestal illustrated in FIG. 1 can be set on a flat surface, such as a table or countertop for example, with the base resting against such flat surface. A plate, serving dish, platter, etc., (referred to as the target device) can then be centered over the suction cup 160 and then pressed downward. The pressure from the bottom surface of the target device pushes against the lips of the suction cup to begin forcing air out of the cavity, or causing the air to vacate the cavity 161. In addition, upward pressure from the support structure 150, at the points where the upper surface 156 contacts the lower surface 162 of the suction cup 160 further operates to evacuate air from the cavity 161. When fully attached, support structure 150 provides support to the suction cup 160 and the target device to limit instability of the target device, such as wobbling. In addition, the finger protrusions 164 along with the tabs 168 rest between the rim 107 of the mating support structure 106 to provide additional stability. It should be appreciated that in other embodiments, any number of fingers 164 may be used to improve the stability and, in some embodiments, rather than fingers, a ring or gasket may exist around the perimeter of the suction cup to provide this additional support. In other embodiments, the fingers may be eliminated or reduced and instead, the diameter of the suction cup may extend to cover, at least partially, the rim 107. Further, the fingers and or the gasket may be made of a more rigid material to provide further support. Yet in other embodiments all portions of the suction cup may be fully contained within the rim 107 and as such, the rim 107 can directly support the object attached to the suction cup 160.

Although the support structure 150 and the upper surface of the support structure is illustrated as being one solid and continuous element, it should be appreciated that the upper surface, as well as the support structure 150 may be constructed of multiple pieces that are independent or secured to each other. For instance, the upper surface may include multiple flat portions with gaps between them. In particular, the upper surface may include three sections so as to provide a three point contact with the underside of the suction cup.

FIG. 2 is a cross-sectional diagram of the assembled attachable pedestal device illustrated in FIG. 1 with the cross-section corresponding to the line A-A in FIG. 1. The cross-sectional view of the support structure 150 shows that the internal bore 158 includes a shelf 153 against which the actuator 140 can apply upward pressure.

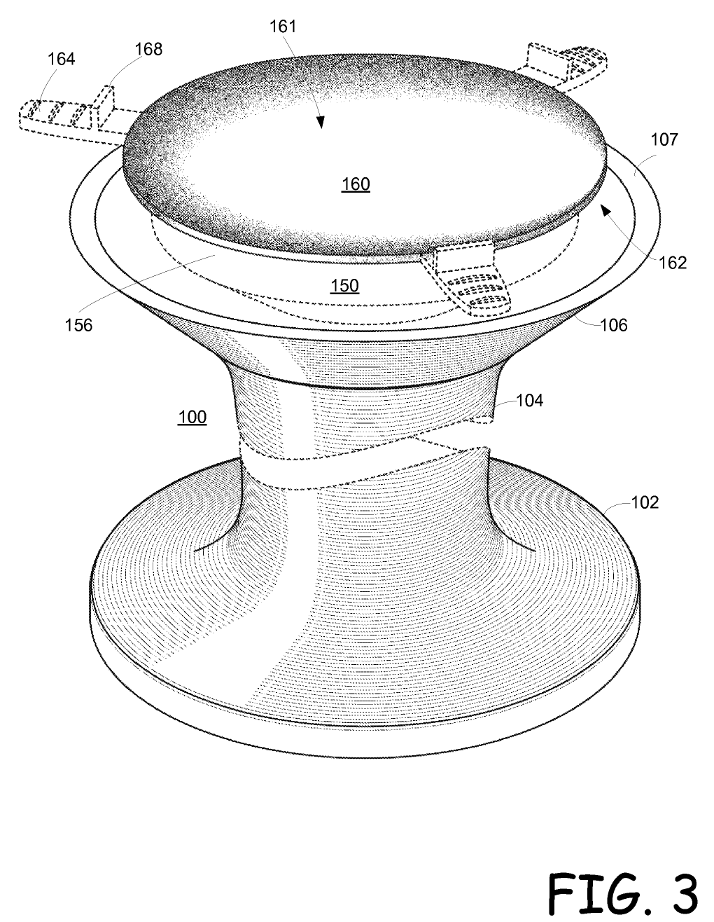

FIG. 3 is a perspective view of an attachable pedestal. In the illustrated embodiment, the neck 104 of the pedestal 100 is shown as being broken indicating that the neck 104 can be of different lengths to provide attachable pedestals of varying heights. In some embodiments, the pedestal 100 may include an upper portion comprised of the mating support 106 and an exterior portion of the neck 104, and a lower portion comprised of the base 102 and an inner portion of the neck 104. In this embodiment, the insert assembly can be attached to the lower portion of the pedestal, and the upper portion can telescopically slide up and down to create pedestals of varying heights. In other embodiments, the exterior of the lower portion of the neck can be threaded and the interior of the upper portion of the neck can be thread. In this embodiment, the height of the pedestal can be adjusted by rotating the upper portion and lower portion of the pedestal in opposite directions to lengthen or shorten the pedestal. Yet in other embodiments, the upper and lower portion can be configured such that sufficient friction exists to allow the pedestal to be adjusted but also prevent the pedestal from moving when loaded with a serving dish.

In some embodiments, just the attachable elements may be embodied in a variety of configurations. For instance, the suction cup 160 and support structure 150 can be included in a variety of environments. As a non-limiting example, these elements can be mounted to a surface, such as a table top, a counter top, a cabinet shelf etc. The surface on which the suction cup 160 and support structure 150 are mounted in essence replace the pedestal and provide a means for the actuator 140 to apply the upper pressure to the support structure 150. In other embodiments, a mating support similar to the mating support 106 of the pedestal may also be included. Such embodiments may advantageously be used to display items in a cabinet or hold items on a table or counter top. Those skilled in the art will appreciate that a wide variety of other uses may also be met by such embodiments. For instance, a vehicle used to transport glass or mirrors may include several such embodiments to hold the glass or mirrors in place. Wall mounted versions of such embodiments may be used to hold art, mirrors, pictures, flat panel monitors, etc. Thus, such embodiments would include a suction cup having a concave surface for attachment to the surface of an object and an opposing surface. Further, it would include a support structure corresponding to the opposing surface of the suction cup, the support structure being biased towards the suction cup such that when pressure is applied against the concave surface of the suction cup by the surface of the object, the support structure applies an opposing pressure against the opposing surface of the suction cup so as to facilitate the evacuation of air from a cavity defined by the concave surface of the suction cup.

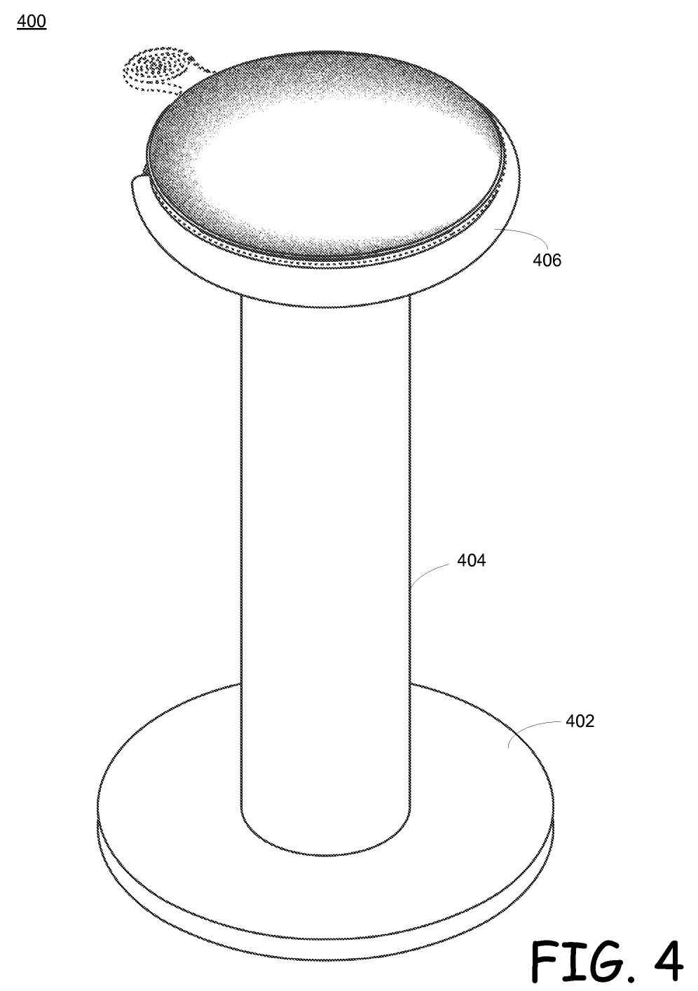

FIG. 4 is a perspective view of another embodiment of an attachable pedestal. In this embodiment, the attachable pedestal 400 includes a pedestal base 402, a stem 404 and a top section 406. It should be appreciated that the particular shapes of the various components are provided for illustrative purposes only and various embodiments may take on different design elements.

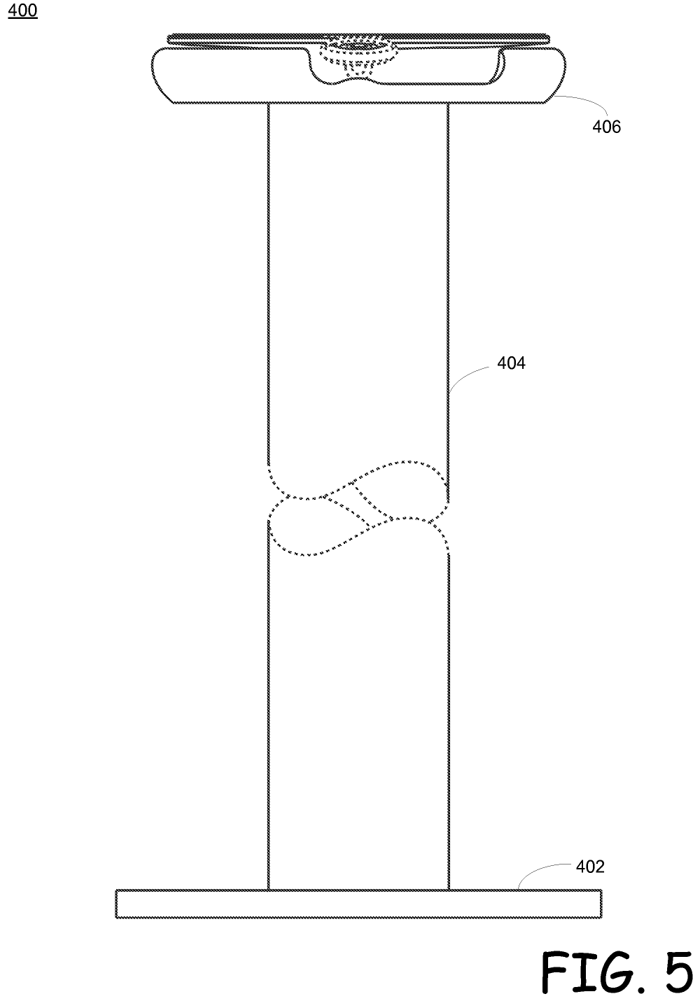

FIG. 5 is a front view of the embodiment of the attachable pedestal illustrated in FIG. 4 and FIG. 6 is a side view of the embodiment of the attachable pedestal illustrated in FIG. 4. In these illustrations, the stem 404 is shown as being broken to further illustrate that the height of the stem can differ in various embodiments. In some embodiments, as previously recited, the stem can be extendable in a variety of manners such as telescoping sections, sections that screw into each other, having multiple sections that can be inserted or removed from the stem, etc.

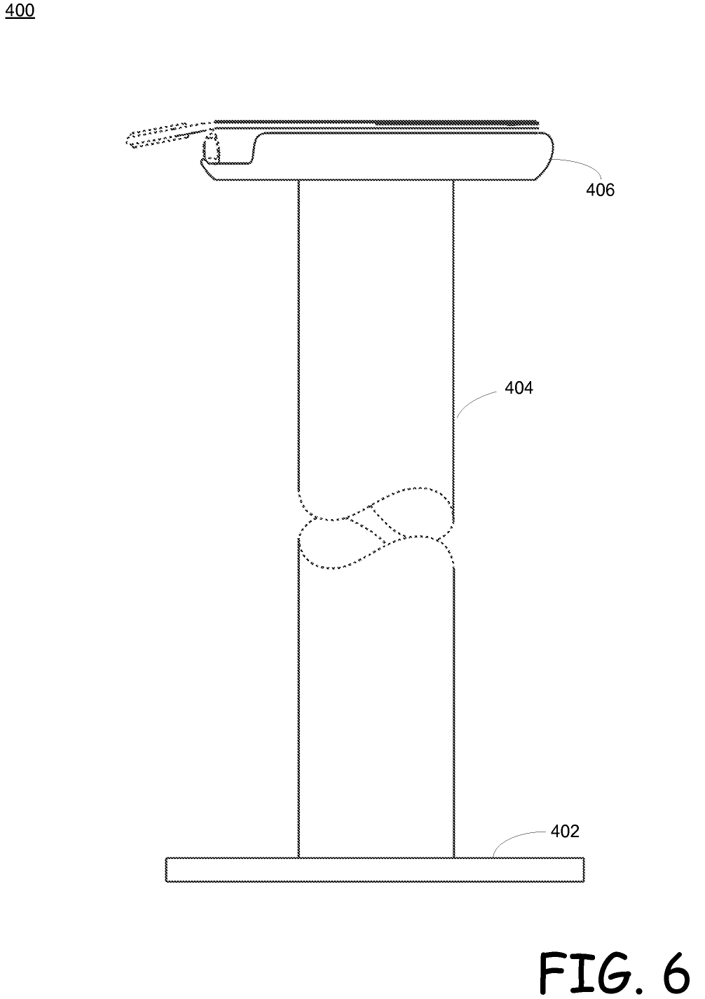

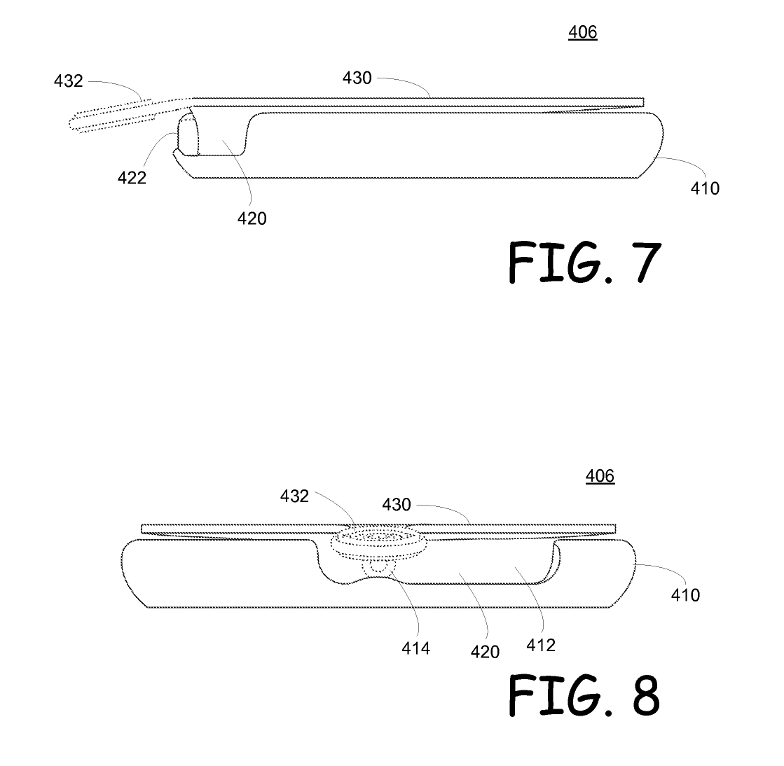

FIG. 7 is an enlarged front view of top section of the embodiment of the attachable pedestal illustrated in FIG. 4 and FIG. 8 is an enlarged side view of the top section of the embodiment of the attachable pedestal illustrated in FIG. 4. The top section 406 is shown as including a base 410 and a center actuator 420 and a suction cup 430. The suction cup 430 is shown as including a single flange 432 that can be used to break a vacuum seal between the suction cup 430 and a device of surface attached thereto. It will be appreciated that in some embodiments more than one flange may be used an in other embodiments, the flange can be eliminated all together and other mechanisms can be employed to break the vacuum seal. In addition, the illustrated shape of the flange is a non-limiting example of one structure for the flange and other shapes may also be used in various embodiments. The center actuator 420 includes a knob 422. The base 410 includes an open area 412 that includes a raised detent 414. As well best be illustrated in conjunction with the description of FIGS. 13A-B, 14A-B and 15A-B, the top section operates by sliding the knob 422 to the far right location of the opening 412 and then placing the suction cup 430 against a substantially flat surface. Once the suction cup 430 is pressed against the substantially flat surface, the knob 422 is then slid to the left side of the opening 412 and over the detent 414 which locks the center actuator 420 in place. As the center actuator 420 rotates clockwise in response to moving the knob 422, the center actuator pulls a central portion of the suction cup away from the substantially flat surface thereby creating a vacuum pressure that secures the suction cup 430 against the substantially flat surface.

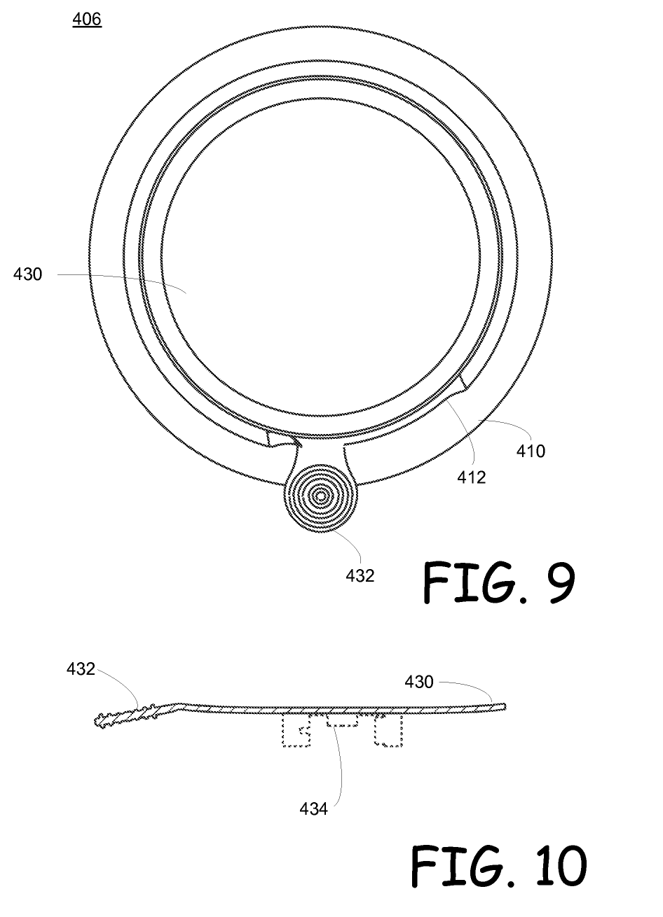

FIG. 9 is an enlarged top view of the embodiment of the attachable pedestal illustrated in FIG. 4.

FIG. 10 is an enlarged side view of the suction cup utilized in the embodiment of the attachable pedestal illustrated in FIG. 4. The suction cup 430 is shown as including an interface 434 which is one embodiment of how the suction cup 430 interfaces to the center actuator 420.

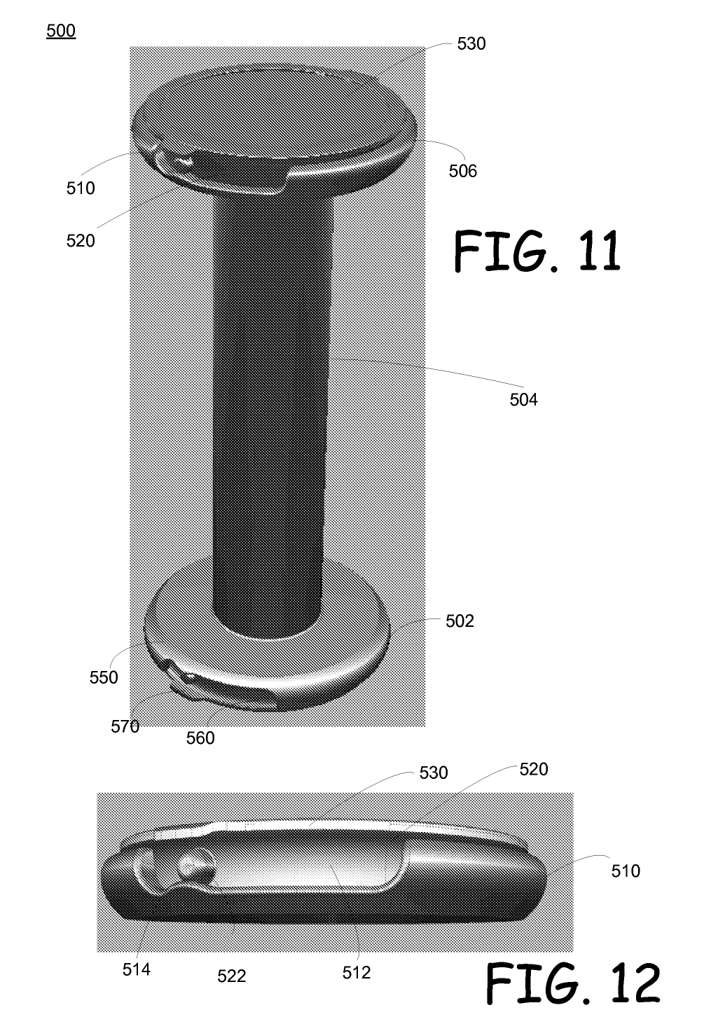

FIG. 11 is a 3D model perspective view of another embodiment of the attachable pedestal. In this embodiment, the attachable pedestal 500 includes a pedestal base 502, a stem 504 and a top section 504. Similar to the embodiment illustrated in FIG. 4, the top section includes a base 510, a center actuator 520 and a suction cup 530. However, in this embodiment, which can equally be applied to any of the disclosed embodiments as well as anticipated embodiments, the pedestal base 502 also includes a base 550, a center actuator 560 and a suction cup 570. Advantageously, the aspect of the various embodiments allows the pedestal 500 to be attached to two substantially flat and opposing surfaces for straight stems, or simply two substantially flat surfaces for stems that include a bend or curve or that can be bent or curved.

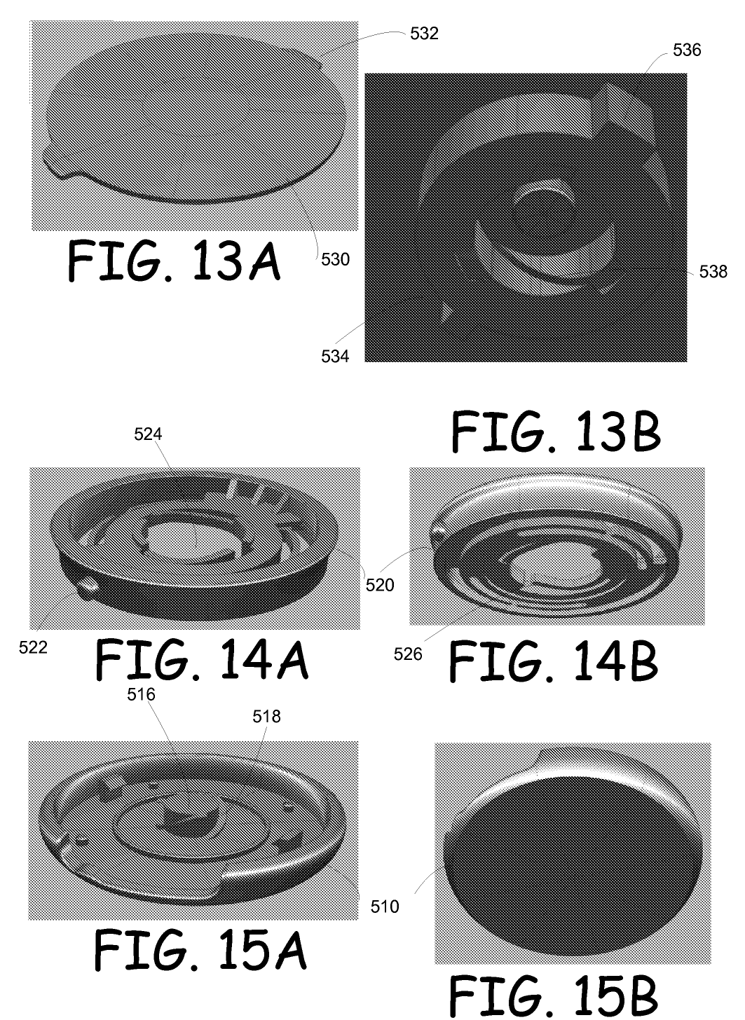

FIG. 12 is a 3D model perspective view of the top and/or bottom section of the embodiment of the attachable pedestal illustrated in FIG. 11. As illustrated, in this embodiment the top section 504, as well as the pedestal base 502, the center actuator 520 may include a knob 522. The base 510 includes an opening 512 that includes a detent 514.

FIGS. 13A-B, 14A-B and 15A-B illustrate an exploded view of the top and/or bottom section of the embodiment of the attachable pedestal illustrated in FIG. 11. The top section 506, as well as the pedestal base 502 illustrated in FIG. 12, includes the suction cup 530 FIG. 13A, the center actuator 520 FIG. 14A and the base 510 FIG. 15A. FIG. 13B illustrates a blown up version of the underside of the suction cup 530 showing an exemplary structure for the interface 534 between the suction cup 530 and the center actuator 520 and the base 510. The interface is placed in the central opening 524 of the center actuator 520 and rests on the central protrusion 516 of the base 510. The interface 534 of the suction cup 530 includes two tabs 536 that rest under the center actuator 520 and freely slide or rotate under the ridge 526. The interface 534 further includes two ramps 538 that mate with the ramps 518 in the protrusion 516 of the base 510. In operation, as the center actuator 520 is rotated clockwise, the tabs 536 slide under the tapered ridge 526 which force the central portion of the suction cup 530 towards the base 510 as the ramps 538 slide along the ramps 518. This action creates a vacuum pressure between the top side of the suction cup a substantially flat surface. When the center actuator is rotated counter clockwise, the ramps 538 of the interface slide up the ramps 518 of the central protrusion 516 of the base 510 thereby forcing the tabs 536 to slide with upward pressure against the ridges 526. This causes the center portion of the suction cup 530 to move away from the base 510 and deplete or reduce the vacuum pressure. In addition, the flanges on the suction cup 530 can be pulled away from the substantially flat surface to deplete the vacuum pressure. It will be appreciated that the knob 522 can be used to rotate the center actuator 520 or, the object being attached to the pedestal can be pressed against the suction cup 530 and rotated clockwise to force the movement of the suction cup 530 and center actuator 520.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. An apparatus for attachment to a surface of an object, the apparatus comprising:
a base having a first surface corresponding with a plane, and a second surface;
a neck that extends from the second surface of the base, the neck having a first end that is proximate to the base and a second end that is distal from the base;
a mating support having a first side and a second side, the first side of the mating support corresponding to and extending from the end of the neck that is distal from the base, the second side including a mating element comprising:
a flexible mating attachment that is attached to the apparatus and configured to attach to a surface of an object; and
a rigid support structure that is separate and distinct from the flexible mating attachment and that is configured to provide support for the flexible mating attachment and the object.

2. The apparatus of claim 1, wherein the mating attachment is a suction cup.

3. The apparatus of claim 2, wherein the support structure is between the second side of the matting support and the suction cup.

4. The apparatus of claim 3, wherein the support structure can be biased to apply a force against the suction cup such that when pressure is applied against one side of the suction cup by pressing the surface of the object against the suction cup, the support structure operates to apply an opposing force on an opposing side of the suction cup.

5. The apparatus of claim 4, wherein the support structure is configured such that the force applied to the opposing side of the suction cups operates to vacate air from the suction cup.

6. The apparatus of claim 5, wherein the neck includes a biasing member that engages with a bottom surface of the support structure and that operates to bias the support structure towards the suction cup.

7. The apparatus of claim 6, wherein the biasing member is a spring.

8. The apparatus of claim 2, wherein the suction cup includes a concave side for mating with the surface of the object and a plurality of flanges corresponding to the periphery of the suction cup and extending in a radial manner from the periphery of the suction cup, at least one or more of the flanges including a tab that extends towards the concave side of the suction cup, wherein when the object is attached to the suction cup, the tabs provide additional support to the object.

9. The apparatus of claim 8, wherein the suction cup is rigidly attached to the apparatus.

10. The apparatus of claim 9, wherein the neck defines an interior cavity and further comprising a threaded aperture that is accessible through the interior cavity of the neck accessible through an opening in the end neck located that is distal from the base, and the suction cup includes a threaded rod that can be mated with the threaded aperture to provide the rigid attachment of the suction cup to the apparatus.

11. The apparatus of claim 10, wherein the support defines an aperture through which the threaded rod is be extended when assembled.

12. The apparatus of claim 10, wherein the threaded aperture is integral to an insert that can be attached to the combination of the base and neck.

13. The apparatus of claim 2, wherein at least a portion of the neck is substantially perpendicular to the first plane.

14. An apparatus for attachment to the surface of an object, the apparatus comprising:
a suction cup having a concave surface for attachment to the surface of an object and an opposing surface; and
a support structure corresponding to the opposing surface of the suction cup, the support structure being biased towards the suction cup such that when pressure is applied against the concave surface of the suction cup by the surface of the object, the support structure applies an opposing pressure against the opposing surface of the suction cup so as to facilitate the evacuation of air from a cavity defined by the concave surface of the suction cup.

15. The apparatus of claim 14, further comprising:
a base having a first surface and a second surface, the first surface of the base being substantially flat and defining an outer edge, the second surface of the base being substantially tapered inward from the outer edge such that the first surface of the base is substantially wider than an upper portion of the second surface of the base;
a neck that extends from the upper portion of the second surface of the base substantially perpendicular to the first surface, the neck having a first end that is proximate to the base and a second end that is distal from the base, the neck being substantially narrower than the first surface of the base;
a mating support having a first side and a second side, the first side of the mating support corresponding to and extending from the end of the neck that is distal from the base, the second side receiving the suction cup and the support structure.

16. The apparatus of claim 15, wherein the opposing side of the suction cup includes a threaded stem extending from the suction cup in the opposite direction of the concave surface, and further comprising an assembly comprising:
an insert that is configured to slide into the interior of the neck and including an interior structure defining a threaded aperture centered coaxially within the insert;
a spring that is configured to fit inside the insert with a first end of the spring resting on the interior structure of the insert;
a means for securing the insert within the interior of the neck; and
an opening in the insert for receiving the narrow end of the support structure;
wherein the insert can be inserted into the neck and secured into position, the spring can be inserted into the insert, the support structure can be inserted into the opening of the insert with the inserted end of the support structure resting against a second end of the spring, and the suction cup can be attached to the insert by inserting the threaded stem through a hole defined by the support structure, through the center of the spring and threading the threaded stem into the threaded aperture of the insert.

17. The apparatus of claim 16, wherein the base, the neck and the mating support are an integral piece.

18. The apparatus of claim 16, wherein the wide end of the support structure has a substantially flat surface and the spring biases the support structure towards the suction cup such that upon application of pressure against the concave surface of the suction cup by the surface of the object, the support structure applies pressure against the opposing side of the suction cup.

19. The apparatus of claim 17, wherein the opposing surface of the suction cup includes a stem and a convex surface, and the support structure defines a cavity for receiving the stem of the suction cup and a surface that is in contact with the convex surface of the suction cup.

20. A method for securing an object to an apparatus, the method comprising the steps of:
placing a surface of an object onto a suction cup portion of an apparatus, the apparatus comprising:
a base having a first surface corresponding with a plane, and a second surface;
a neck that extends from the second surface of the base, the neck having a first end that is proximate to the base and a second end that is distal from the base;
a mating support having a first side and a second side, the first side of the mating support corresponding to and extending from the end of the neck that is distal from the base, the second side including a mating element comprising:
the suction cup having a concave surface, for attachment to the surface of the object, and an opposing surface; and
a support structure corresponding to the opposing surface of the suction cup, the support structure being biased towards the suction cup; and
placing pressure on the object such that the surface of the object places a positive force in a first direction against the concave surface of the suction cup and, at the same time the support structure applies an opposing positive force to the opposing surface of the suction cup so as to facilitate the evacuation of air from a cavity formed by the concave surface of the suction cup and also providing additional support to the object.
